(19) United States
(12) Patent Application Publication
(10) Pub. No.: US 2005/0253912 A1
(43) Pub. Date: Nov. 17, 2005

(54) Humidity calibration

(76) Inventors: David E. Smith, Vancouver, WA (US); Bryan Bihlmaier, Vancouver, WA (US); Algird M. Gudaitis, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/848,332

(22) Filed: May 17, 2004

(51) Int. Cl. B41J 2/01

(52) U.S. Cl. 347/102

(57) ABSTRACT

Methods, apparatus, and systems are provided for humidity calibration. One apparatus includes a housing in an image forming system. A temperature sensor and a humidity sensor are associated with the housing. A module for humidity calibration is coupled to the temperature sensor and the humidity sensor.

### INTRODUCTION

Various imaging devices deposit fluid on media that takes time to dry. Uncontrolled, wet media can affect output quality. An environmental factor, humidity, is relevant to printer performance and can affect inkjet printing and media drying routines. Solid State humidity sensors experience calibration drift with time. Some sensor manufacturers utilize long process times and other techniques to reduce drift. Even so, appreciable residual drift remains in the delivered product. Contamination can also cause a change in humidity sensor accuracy over a period of use in the field.

### BRIEF DESCRIPTION OF THE DRAWINGS

FIG. 1A illustrates an embodiment of an image forming device.

FIG. 1B illustrates another embodiment of an image forming device.

FIG. 1C illustrates another embodiment of an image forming device.

FIG. 2 illustrates a block diagram of an embodiment of electronic components for an embodiment of an image forming device.

FIG. 3A illustrates an embodiment of an image forming system including the capability to calibrate for relative humidity.

FIG. 3B illustrates another embodiment of an image forming system including the capability to calibrate for relative humidity.

FIG. 3C illustrates another embodiment of an image forming system including the capability to calibrate for relative humidity.

FIG. 4 illustrates a method embodiment.

FIG. 5 illustrates another method embodiment.

FIG. 6 illustrates another method embodiment.

### DETAILED DESCRIPTION

Embodiments of the invention include an inkjet apparatus that has an inkjet dryer and a relative humidity calibration module coupled thereto. A housing of the inkjet dryer has a surface including a nozzle and/or array of nozzles opposing a media path. The housing contains a temperature sensor and a relative humidity sensor. The housing additionally includes a blower to direct a gas through the housing across a heating element and to expel the gas through the nozzle. The relative humidity calibration module is coupled to the temperature sensor and the relative humidity sensor to recalibrate the relative humidity sensor based on periodic temperature and relative humidity measurements at different temperatures over an interval of use of the dryer in field. The relative humidity calibration module can compare a first temperature and relative humidity measurement at a first interval to a second temperature and relative humidity measurement at a second interval.

In various embodiments the housing includes a substantially sealable chamber to limit air flow into and out of the housing between dryer operation. For example, in one embodiment, the blower and the nozzles include closures which seal the housing shut between dryer operation and/or during the periodic temperature and relative humidity measurements. In one embodiment the housing includes a first chamber and a second chamber. The blower is connected between the first chamber and the second chamber and creates a negative pressure to draw gas from the first chamber into the second chamber and to expel the gas through the nozzles. Additionally in this embodiment, the blower draws the gas expelled through the nozzles back into the first chamber.

As will be apparent from this disclosure, the dryer directs heated air over an inkjet image through impinging nozzles during and after the printing process to accelerate image dry time. In some embodiments the drying efficiency is increased by recirculating the heated air after it has passed over the media, rather than expelling the air out of the printer. This combination of recirculating the warm air and using impinging nozzles reduces the heating power used to sufficiently dry inkjet printed media.

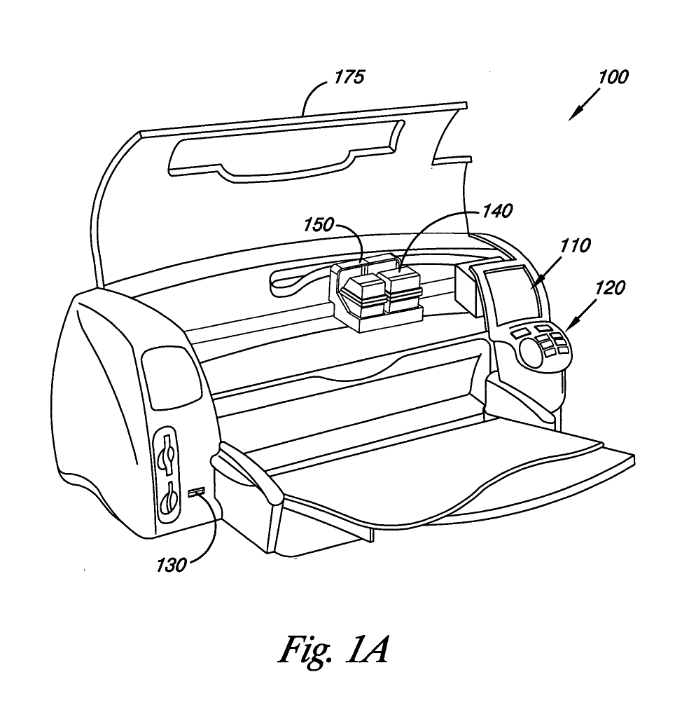

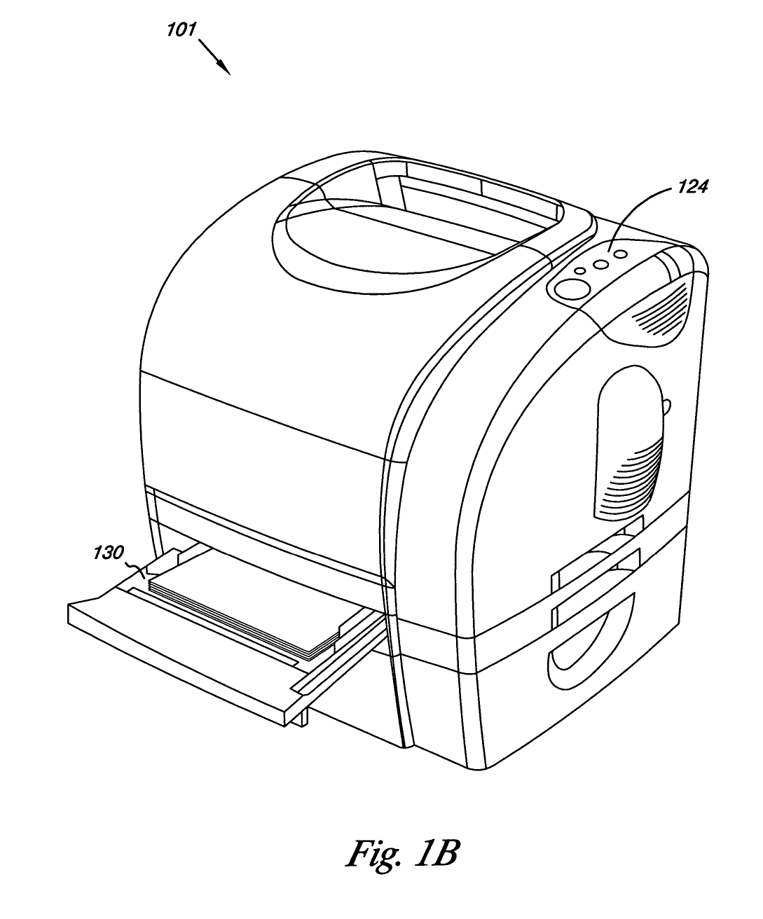

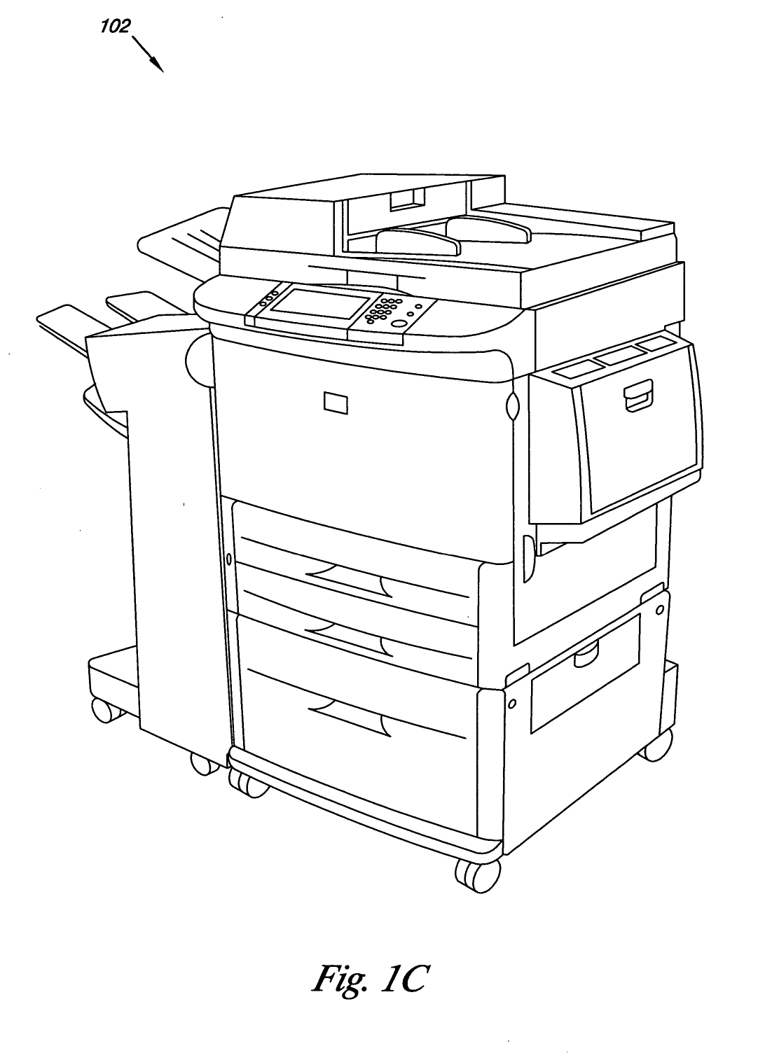

FIG. 1A provides a perspective illustration of an embodiment of an image forming device 100, such as a printing device, which is operable to implement, or which can include, embodiments of the invention. The embodiment of FIG. 1 illustrates an inkjet printing device 100 which can be used in an office or home environment. Embodiments of the invention can include other types of image forming devices as illustrated in FIGS. 1B and 1C. As illustrated in FIG. 1A, the image forming device (printing device 100) includes a number of user interface input/output (I/O) control mechanisms such as an input keypad 120 for data entry and an I/O port 130 for receiving data from other devices as well as display means 110. Embodiments, however, are not limited to the configuration shown in FIG. 1A. The printing device 100 can operate as a stand alone device and/or can be used as a printing device in a networked system.

In the embodiment shown in FIG. 1A the printing device 100 includes a print cartridge 140 mounted in a movable print carriage 150. The print cartridge 140 contains both an ink reservoir and a printhead for ejecting ink onto print media. The movable print carriage 150 can scan the print cartridge 140 across the print media while performing a print job. Embodiments of the invention, however, are not limited to application with a movable print carriage. For example, embodiments include inkjet printing devices in which print media moves underneath a stationary print cartridge.

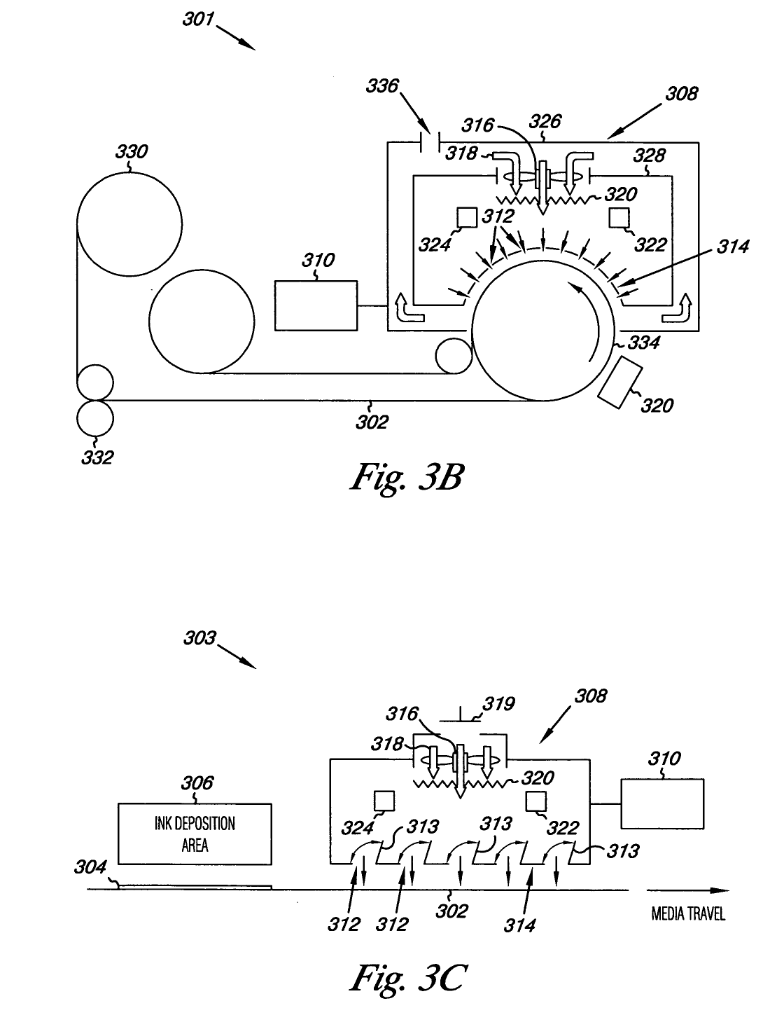

FIG. 1B illustrates another embodiment of an image forming device. FIG. 1B is presented to illustrate another configuration of an image forming device. The embodiment of FIG. 1B can include the components discussed above. The embodiment of FIG. 1B depicts a larger volume image forming device 101 with a control console 124 provided to a user on the top of the device 101 and one or more print media supply trays 130 provided underneath. As with FIG. 1A, the console 124 can be used to enter information into the printing device 102. The embodiment of FIG. 1B may additionally include a drum media conveyance mechanism, as discussed in connection with FIG. 3B. The printing device 101 embodiment of FIG. 1B is illustrated as another example device structure which can implement embodiments of the invention. Embodiments, however, are not limited to the device structural design shown in FIG. 1B.

FIG. 1C illustrates another embodiment of an image forming device 102 with which embodiments can be implemented. The embodiment of FIG. 1C illustrates a multifunction inkjet printer 102, which can be used in a business environment for reports, correspondence, desktop publishing, pictures and the like. The embodiment of FIG. 1C depicts yet a larger volume image forming device than that shown in FIG. 1B. The embodiment of FIG. 1C may also include a drum media conveyance mechanism, as discussed in connection with FIG. 3B. Again, embodiments of the invention are not limited to the image forming device examples illustrated in FIGS. 1A-1C.

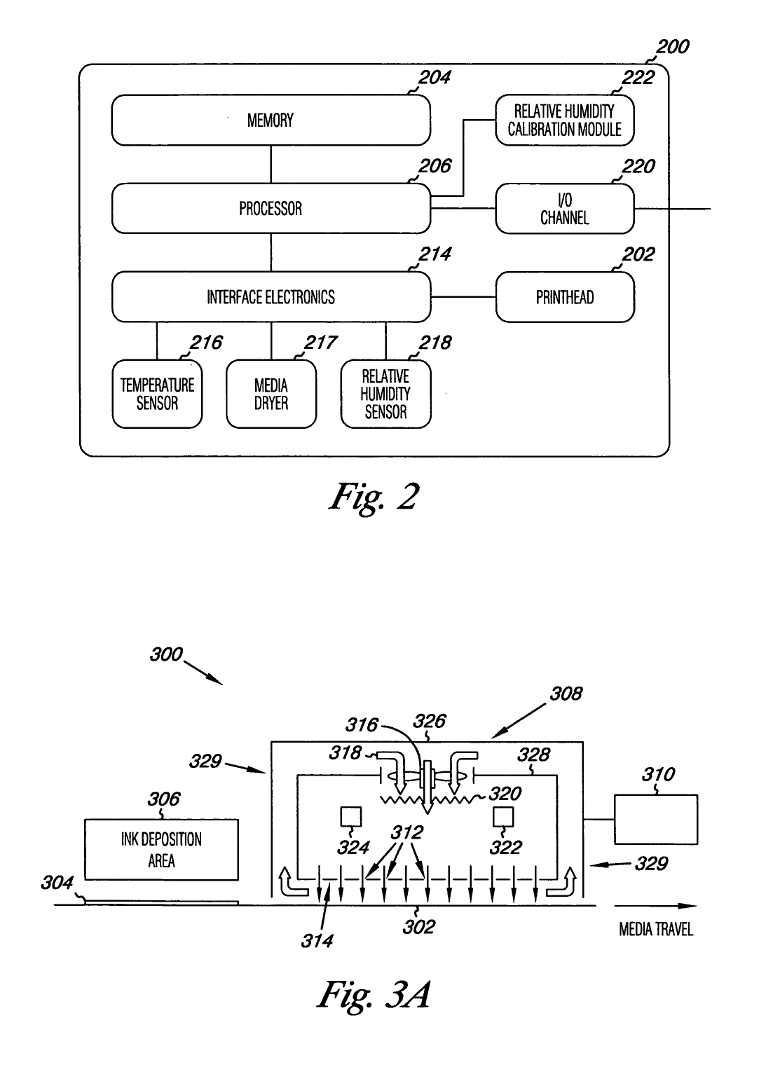

FIG. 2 illustrates an embodiment of the electronic components associated with a printing device 200, such as printing devices 100-102 shown in FIGS. 1A-1C. As shown in FIG. 2, the electronic components of printing device 200 include a media marking mechanism such as printhead 202. Electronic components of printing device 200 also include control logic in the form of executable instructions which, for example, can exist within memory 204 and can be executed by a controller or processor, such as processor 206, to eject ink drops onto the print media. The executable instructions carry out various control steps and functions for the printing device 200. Memory 204 can include some combination of ROM, dynamic RAM, magnetic media, and optically read media, and/or some type of nonvolatile and writeable memory such as battery-backed memory or flash memory.

The processor 206 is operable on software, e.g., computer executable instructions, received from memory 204 or via an input/output (I/O) channel 220. The embodiments of the invention, however, are not limited to any particular type of memory and are not limited to where within a device or networked system a set of computer instructions reside for use in implementing the various embodiments of invention.

The processor 206 can be interfaced, or connected, to receive instructions and data from a remote device, e.g., over a local area and/or wide area network (LAN/WAN), through one or more I/O channels or ports 220. I/O channel 220 can include a parallel or serial communications port, and/or a wireless interface for receiving data and information, e.g. print job data, as well as other computer executable instructions, e.g., software routines.

Interface electronics 214 are associated with the printing device 200 to interface between the control logic components and the electromechanical components of the printer such as the printhead 202. As illustrated in FIG. 2, the interface electronics 214 are coupled to a media dryer 217 such as an inkjet dryer. One of ordinary skill in the art will appreciate the manner in which interface electronics can be coupled to a media dryer 317 to control the operation thereof. The interface electronics 214 are further coupled to a temperature sensor 216 and a relative humidity sensor 218. By way of example and not by way of limitation, the temperature sensor 216 can include a thermal sense resistor (TSR) and/or a digital temperature sensor (DTS). As one of ordinary skill in the art will appreciate, relative humidity sensors are of several types. Some humidity sensors use a humidity sensitive polymer on a porous ceramic plate. The capacitance or resistivity of the polymer changes as a function of relative humidity. Another type of humidity sensor employs a capacitor with an air dielectric. Since the dielectric constant of air is one and the dielectric constant of water is about 80, changes in the relative humidity between the capacitor plates changes the dielectric, and, hence the capacitance of the sensor. An example of such a sensor is sold under the trade name MiniCap by Panametrics of Waltham, Mass.

The embodiment of FIG. 2 further illustrates that the processor 206 is interfaced with a relative humidity calibration module 222. The relative humidity calibration module 222 can execute instructions according to software to receive a temperature measurement and a relative humidity measurement from the temperature sensor 216 and the relative humidity sensor 218, respectively, at various intervals. The relative humidity calibration module 222 can execute instructions to compare a first temperature and relative humidity measurement at a first interval to a second, e.g., different, temperature and relative humidity measurement at a second interval. The relative humidity calibration module 222 can execute instructions to apply, according to a multi-parameter fit equation such as Antoine's Equation for the partial pressure of a gas, interpolation of points to a table stored in memory or other curve fit operation, the first and the second temperature and relative humidity measurements taken at two different temperatures to produce a correction factor (or correction offset). The correction factor can be used to reflect and correct for an accuracy change, whether attributable to a sudden change, e.g., from contamination, and/or attributable to drift of the relative humidity sensor over a period of use in the field. The relative humidity calibration module 222 can be implemented as a logic circuit such as an application specific integrated circuit (ASIC) and can include software and/or firmware.

As one of ordinary skill in the art will appreciate, the partial pressure of a gas is defined by its temperature and several characteristic constants. According to the various embodiments, the module 222 can execute instructions to receive a first temperature measurement (T1) of a gas, e.g., received from the temperature sensor 216 as described above, and to calculate the partial pressure of the gas by employing the appropriate equations and the appropriate characteristic constants.

Further, as one of ordinary skill in the art will appreciate, dew point can be expressed as a function of relative humidity and of partial pressure. As described above, a partial pressure, e.g., PP1, can be calculated at the first temperature, T1. While at the first temperature, T1, the module 222 can execute instructions to receive a first relative humidity measurement (RH1), e.g., received from the relative humidity sensor 218 as described above. The module 222 can additionally execute instructions to calculate a first dew point (Td1), employing the appropriate equations, based on the first relative humidity measurement (RH1) and the above calculated partial pressure (PP1).

By way of example and not by way of limitation, this disclosure takes into account that within a closed volume absolute humidity, e.g., dew point, remains constant, while relative humidity (RH) varies with temperature (T). Thus, if the relative humidity (RH1) is measured at an initial temperature (T1) then by increasing (or decreasing) the volume's temperature to a new value (T2), a new value for relative humidity (RH2) can be measured.

One of ordinary skill in the art will appreciate the manner in which a volume's temperature can be raised to a second temperature, T2, using a heating element, e.g. heating element 320 described below in FIGS. 3A-3C, and measured using the temperature sensor 216. While at the second temperature, T2, the module can execute instructions to receive a second relative humidity measurement (RH2), e.g., received from the relative humidity sensor 218 as described above. The module 222 can additionally execute instructions to calculate a second partial pressure (PP2) of the volume at the second temperature, T2. A second dew point value (Td2), can then be calculated based on the second relative humidity measurement (RH2) and a new calculated partial pressure, PP2 at the second temperature measurement, T2.

As noted above, within a closed volume the absolute humidity, e.g., dew point, should remain the same. According to the various embodiments, the present disclosure describes devices and methods for maintaining a substantially closed volume between temperature and relative humidity measurements, e.g., T1/T2 and RH1/RH2. Thus, the calculated values for Td1 and Td2 should equate, e.g., Td1=Td2.

In instances where Td1 and Td2 do not equate, the error may be attributable to a change in the accuracy of the relative humidity sensor 218. According to the various embodiments, this change in accuracy, whether caused by sensor drift over time and/or contamination can be accounted for by having the module 222 calculate and apply a correction factor.

For example, with values calculated (e.g., by instructions executed by the module 222) for the partial pressure PP1 at temperature T1 and the partial pressure PP2 at temperature T2, and using the measured first relative humidity RH1 at T1, an expected value for the second relative humidity measurement RH2′ can be calculated. That is, the module 222 can execute instructions to solve for RH2′ working from the relationship that Td1 should equal Td2 in a substantially closed volume. The module 222, can execute instructions to compare the actual measured value for RH2 to the expected value of RH2′. The module 222 can then use the difference between the expected value for the second relative humidity measurement and the actual second relative humidity measurement (e.g., RH2′−RH2) as a correction factor (or correction offset) and apply that correction factor to subsequent measurements by the relative humidity sensor 218.

According to various embodiments, the relative humidity calibration module 222 can execute instructions to recalibrate relative humidity based on the first and second temperature and relative humidity measurements when the first and second temperature and relative humidity measurements are taken within a substantially closed environment. The relative humidity calibration module 222 can additionally execute instructions to provide a calibrated relative humidity feedback to the relative humidity sensor 218 in order to adjust the relative humidity sensor 218 to correct for accuracy change in the relative humidity sensor over time while the relative humidity sensor 218 is in use in various environments. One of ordinary skill in the art will appreciate upon reading this disclosure, the manner in which program instructions can be executed by the relative humidity calibration module 222 to provide a feedback, e.g., a calibrated relative humidity feedback, to the relative humidity sensor 218 to compensate for environmental factors (contamination, drift, etc.) impacting the measurement taken by the relative humidity sensor 218 over a period of use of the inkjet dryer 217 in the field. In the various embodiments the first and second temperature and relative humidity measurements are taken within a substantially closed environment while the inkjet dryer 217 is not in use physically drying media.

As will be described in more detail below, the relative humidity calibration module 222 can also execute instructions to calculate a correction factor, e.g., a relative humidity offset, which can be stored in memory 204 and applied when relative humidity (RH) is referenced by processor 206. For example, rather than actually adjusting the relative humidity sensor 218, when a relative humidity measurement is taken by execution of instructions with the relative humidity sensor 218 the instructions can execute to apply the correction factor to the relative humidity measurement reading.

FIG. 3A illustrates an embodiment of an image forming system 300 including the capability to calibrate for relative humidity. As shown in the embodiment of FIG. 3 the image forming system 300 includes media path 302, e.g., a media conveyance mechanism. The media path is operable to convey print media 304, whether in sheet or web form, past an ink deposition area 306. The ink deposition area includes an ink deposition mechanism such as inkjet printheads in a carriage conveyed across the print media and/or web media conveyed underneath stationary printheads. One of ordinary skill in the art will appreciate the various types of ink deposition mechanisms.

As shown in the embodiment of FIG. 3A the image forming system 300 further includes a media dryer 308 coupled to a relative humidity calibration module 310 as described above in connection with FIG. 2. For ease of illustration the media dryer 308 will be referred to herein as an inkjet dryer to symbolize use with inkjet printheads. However, the ink dryer 308 can be used for drying media having fluid deposited thereon from means other than inkjet printheads. As shown in the embodiment of FIG. 3A, the print media 304 is conveyed past the inkjet dryer 308 along a direction of media travel on the media path 302 downstream from the ink deposition area 306. However, one of ordinary skill in the art will appreciate upon reading this disclosure that the inkjet dryer 308 can be positioned and/or configured for use concurrently with the printing process in the ink deposition area 306. Embodiments are not limited to the positioning shown. In some embodiments a media dryer 308 is moved past stationary media 304.

The inkjet dryer 308 is configured in relation to the media path 302 in order to provide a substantially closed housing as described in more detail below. The substantially closed housing allows for the application of a multi-parameter fit equation related to experimental vapor pressures measured over a restricted temperature range, such as Antoine's Equation for partial pressure of a gas. For example, in various embodiments the equation is used to calculate the expected partial pressure of water vapor in air. In these embodiments, temperature and relative humidity measurements can be taken at two different temperatures in a manner that can be used to measure accuracy change of a relative humidity sensor over a period of use in the field. One of ordinary skill in the art will appreciate the manner in which other curve fit equations can be used or interpolation of points in a look-up table stored in memory can be applied in connection with the calibration process.

As shown in the embodiment of FIG. 3A, the inkjet dryer 308 includes at least one nozzle 312 on a surface 314 opposing the media path 302, although a multiple of nozzles can be provided. One of ordinary skill in the art will appreciate the manner in which a nozzle can be formed in and/or with a surface 314 opposing the media path 302. As illustrated, the inkjet dryer 308 includes a blower 316 to direct gas 318 through the housing. The inkjet dryer includes a heating element 320 located proximate to the blower 316 to heat gas 318 moving through the housing. One of ordinary skill in the art will appreciate the various types of blowers 316 and heating elements 320 which can be implemented in an inkjet dryer 308. The inkjet dryer 308 further includes a temperature sensor 322 and a relative humidity sensor 324, as the same have been described above in connection with FIG. 2, within the housing 308. Circuitry, as shown in FIG. 2, can connect the temperature sensor 322 and the relative humidity sensor 324 to the relative humidity calibration module 310.

As shown in the embodiment of FIG. 3A the inkjet dryer housing 308 includes a first chamber 326 (e.g., an outer chamber or recirculation chamber) and a second chamber 328 within the first chamber 326. The blower 316 is connected or located between the first chamber 326 and the second chamber 328. The nozzles 312 are shown with a surface 314 of the second chamber 328 opposing the media path 302. The heating element 320 is illustrated within the second chamber 328 although embodiments are not so limited. The temperature sensor 322 and the relative humidity sensor 324 are also illustrated within the second chamber 328 although embodiments are also possible with the sensors, 322 and 324, located between the first chamber 326 and the second chamber 328 and/or in the first chamber 326.

As shown in the embodiment of FIG. 3A, the blower 316 creates a negative pressure in the first chamber 326 to draw a gas 318, e.g., ambient air or other gas, from the first chamber 326 into the second chamber 328 and creates a positive pressure in the second chamber 328 to expel the gas 318 through the nozzles 312 toward the media path 302. According to the various embodiments, the first chamber 326 encompasses the second chamber 328 such that the negative pressure created by the blower 316 draws the gas 318 expelled through the nozzles 312 back into the first chamber 326. In the various embodiments, the first chamber 326 includes sidewalls 329 bounding an open surface opposing the media path 302. The sidewalls 329 of the first chamber 326 are maintained in a sufficiently close proximity to the media path 302 so as to create an approximately closed chamber. For example, the sidewalls 329 may be separated enough to still permit media 304 to pass underneath on the media path 302. In this manner, substantially all of the gas 318 expelled from the nozzles 312 is drawn back into the first chamber 326 by the negative pressure of the blower 316.

According to the various embodiments, the relative humidity calibration module 310 receives temperature and relative humidity measurements taken by the temperature sensor 322 and the relative humidity sensor 324 over a number of time intervals. That is, the relative humidity calibration module 310 can execute instructions to record the first temperature and relative humidity measurement at a first temperature and can record a second temperature and relative humidity measurement at the second temperature. The relative humidity calibration module 310 can execute instructions to compare a temperature and a relative humidity measurement at one interval, e.g., recorded for a first temperature (T1), to a temperature and a relative humidity measurement at another interval, e.g., recorded for a second temperature (T2). According to the various embodiments the temperature and relative humidity measurements recorded at a first temperature (T1) and the temperature and relative humidity measurements recorded at a second temperature (T2) are taken while the dryer is not being used to dry printed media, so that the absolute humidity (total mass of water in the air) does not change between the two temperature and humidity measurements. One of ordinary skill in the art will appreciate the manner in which the heating element can be operate by executable instructions to create an environment for taking temperature and relative humidity measurements at two different temperatures.

Because the embodiments discussed herein for the configuration of the inkjet dryer housing 308 maintain a substantially closed volume or sufficiently closed box environment for the gas 318, the relative humidity calibration module 310 can execute instructions to apply the first temperature and relative humidity measurement taken at the first temperature and the second temperature and relative humidity measurement taken at the second temperature according to a multi-parameter fit equation such as Antoine's Equation for the partial pressure of a gas, interpolation of points to a table stored in memory or other curve fit operation, to calibrate for relative humidity. The relative humidity calibration module 310 can execute instructions to provide a calibrated relative humidity feedback to the relative humidity sensor 324 located in the second chamber 328, e.g., execute instructions to adjust the relative humidity sensor based on the relative humidity calibration. Additionally or alternatively, the relative humidity calibration module 310 can execute instructions to calculate a correction factor, e.g., a relative humidity offset, which can be stored in memory and applied when relative humidity (RH) is referenced by processor. For example, rather than actually adjusting the relative humidity sensor 324, when a relative humidity measurement is taken by execution of instructions with the relative humidity sensor 324 the instructions can execute to apply the correction factor or calibration offset to the relative humidity measurement reading. In this manner, separate reference sensors and/or circuits are not involved and the relative humidity sensor 324 can be adjusted to calibrate and to correct for a change in an accuracy of measurement readings provided by the relative humidity sensor 324 contained in the inkjet dryer over a period of use of the dryer in the field.

FIG. 3B illustrates another embodiment of an image forming system 301 including the capability to calibrate for relative humidity. The embodiment shown in FIG. 3B includes a media path 302 conveying a web of print media from a media roll 330 through platens or mechanical rollers 332 to a rotating drum 334, e.g., a cylindrical drum. As one of ordinary skill in the art will appreciate, the rotating drum 334 can convey the web of print media past an ink deposition area 320 as the same has been described in connection with FIG. 3A. Additionally the embodiment of FIG. 3B illustrates a media dryer 308 such as for use as an inkjet dryer.

The media dryer 308 includes the components and dual chamber structure as discussed and described in detail above in connection with FIG. 3A. Additionally, however, the embodiment illustrated in FIG. 3B demonstrates that the surface 314 of the media dryer opposing the rotating drum 334 which conveys the print media 302 opposes approximately half of the rotating drum 334 in a semicircular fashion, e.g., over a circumference that covers approximately 180 degrees. Embodiments for dimensions and shape of the surface 314 are not limited to the examples shown herein, e.g. the dryer can cover a portion of the drum less than and/or greater than 180 degrees. One of ordinary skill in the art will appreciate additional useful constructions which are considered within the scope of this disclosure.

Further, in some embodiments, such as the embodiment shown in FIG. 3B, the first chamber 326 can include a vent 336 which is sized so as not to compromise the sufficiently closed box configuration of the media dryer 308 relative to the media path 302. In such embodiments the blower 316 creates a negative pressure, as described above, to draw in ambient air to the first chamber 326. In various embodiments the vent 336 can further include a sealing mechanism such as a lid and/or cover to selectably seal the vent when temperature and relative humidity measurements are being taken for calibration. One of ordinary skill in the art will appreciate that measurements can also be taken during operation to monitor dryer conditions and that during the physical dryer operation the vent 336, blower 316 and nozzles 312 would not be closed.

FIG. 3C illustrates another embodiment of an image forming system 303 including the capability to calibrate for relative humidity. The media dryer 308 embodiment of FIG. 3C illustrates many of the components discussed and described in detail above in connection with FIG. 3A and can include a drum and/or vent as shown in connection with FIG. 3B. FIG. 3C illustrates an embodiment which does not include a dual chamber structure, e.g., the outer recirculation chamber 326 in FIGS. 3A and 3B. Instead, the embodiment of FIG. 3C illustrates that the blower 316 and the nozzles 312 are provided with a sealing or closure mechanism, 319 and 313 respectively, such as a lid and/or cover to selectably seal the openings to the dryer 308 when temperature and relative humidity measurements are being taken. Thus, this example embodiment also provides a substantially closed or sealable housing to the dryer 308 such that executable instructions can apply, e.g., according to Antoine's Equation for the partial pressure of a gas, interpolation of points to a table stored in memory or other curve fit operation, temperature and relative humidity measurements taken at two different temperatures to produce a correction factor (or correction offset) that can be used to measure accuracy change of a relative humidity sensor over a period of use in the field.

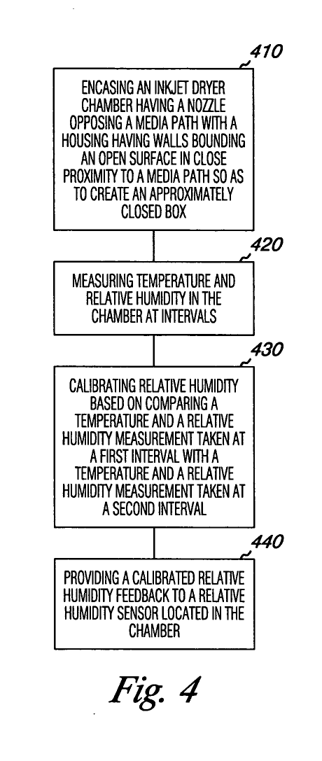

FIGS. 4-6 illustrate various method embodiments for humidity sensor calibration (e.g., relative humidity offset calibration), and/or additionally communicating such a calibration to a relative humidity sensor in a media dryer (e.g., in order to adjust a relative humidity sensor) while the media dryer is in the field of commercial use. As one of ordinary skill in the art will understand, the embodiments can be performed by software/firmware (e.g., computer executable instructions) operable on the devices shown herein or otherwise. That is, calibration instructions can also be contained on a separate module used by field service technicians to calibrate the sensor during service visits. In these embodiments, a field service technician could connect the calibration module to the image forming device during service and then disconnect it after the calibration was complete.

Embodiments of the invention are not limited to any particular operating system or to software written in a particular programming language. Unless explicitly stated, the method embodiments described herein are not constrained to a particular order or sequence. Additionally, some of the described method embodiments can occur or be performed at the same point in time.

FIG. 4 illustrates a method embodiment for calibrating an inkjet dryer. As shown in the embodiment of FIG. 4 the method includes encasing an inkjet dryer chamber having at least one nozzle opposing a media path with a housing having walls bounding an open surface in close proximity to the media path so as to create an approximately closed box, as shown in block 410. Encasing the inkjet dryer includes configuring an outer chamber to create a housing structure as has been described above in connection with FIGS. 3A and 3B, or substantially sealing a chamber as in FIG. 3C. For example, encasing the inkjet dryer includes providing an outer cover having an open surface opposing a contour of a media path. The open surface is bounded by sidewalls which nearly contact the media path while still permitting media on the media path to pass underneath. As described above the proximity of the bounding sidewalls create a substantially closed housing arrangement. As used herein, a substantially closed housing arrangement is to be interpreted as one in which the absolute humidity (e.g., total mass of water in the air) does not appreciably change.

As shown in block 420, the method includes measuring temperature and relative humidity in a chamber of the inkjet dryer at intervals. As described above in connection with FIGS. 2-3C, an inkjet dryer is provided having a temperature sensor and a relative humidity sensor located therein. According to various embodiments, the temperature sensor and the relative humidity sensor are located in an inner chamber of the inkjet dryer, e.g., second chamber 328 as shown in FIGS. 3A and 3B, in an outer chamber, e.g., first chamber 326 in FIGS. 3A and 3B, and/or single chamber 308 as shown in FIG. 3C. The temperature sensor and relative humidity sensor can include sensors mentioned above and other suitable sensors. According to the various embodiments, measuring temperature and relative humidity in the chamber of the inkjet dryer includes measuring temperature and relative humidity at different time intervals (e.g., taking a first reading of the sensors at one point in time and taking another reading of the sensors at a second time interval) between which the temperature in the inkjet dryer is changed by operation of the heating element, e.g., 320 in FIGS. 3A-3C. Thus, taking a first reading of the sensors at a one point in time and taking another reading of the sensors at a second time interval includes recording the sensors' reading at a first temperature and again recording the sensors' reading at a second temperature. As one of ordinary skill in the art will appreciate upon reading this disclosure, the temperature and relative humidity measurements are taken while the inkjet dryer is in the field of commercial use but not while the inkjet dryer is physically in the process of drying media.

According to the embodiment of FIG. 4, the method includes calibrating relative humidity based on comparing a temperature and relative humidity measurement taken at a first interval with a temperature and relative humidity measurement taken as a second interval. As described above, a relative humidity calibration module is coupled to the inkjet dryer. The relative humidity calibration module can include a logic circuit, including firmware and/or software programmable gates, such as an ASIC. The relative humidity calibration module can execute instructions to receive a temperature and relative humidity measurement taken at a first temperature and receive a temperature and relative humidity measurement taken at a second temperature. As noted above a temperature and relative humidity measurement at a first temperature and a temperature and relative humidity measurement at a second temperature can be recorded by the temperature and relative humidity sensors themselves and/or received and stored in memory by operation of the relative humidity calibration module. The relative humidity calibration module can execute instructions with such received information to apply a routine (e.g., set of computer executable instructions) to calibrate a relative humidity correction factor, e.g., by applying the received information to a multi-parameter fit equation such as Antoine's Equation for the partial pressure of a gas, interpolation of points to a table stored in memory or other curve fit operation.

As shown in block 440, the method includes providing a calibrated relative humidity feedback to the relative humidity sensor located in the inkjet dryer chamber. One of ordinary skill in the art will appreciate upon reading this disclosure the manner in which program instructions as described herein can be executed by the relative humidity calibration module or other processor resource to communicate a calibrated humidity feedback to the relative humidity sensor located in the inkjet dryer. Alternatively and/or additionally, the relative humidity calibration sensor can execute instructions to apply a relative humidity correction factor, as described above, to subsequently received relative humidity measurements taken by the relative humidity sensor. In this manner, the program embodiments can be executed to calibrate and correct for a change in an accuracy of measurement readings for a relative humidity sensor contained in the inkjet dryer over a period of use. As a result, a lower total cost of ownership due to a lower initial cost of the inkjet dryer, less energy used for drying, and a decrease in maintenance costs can be realized.

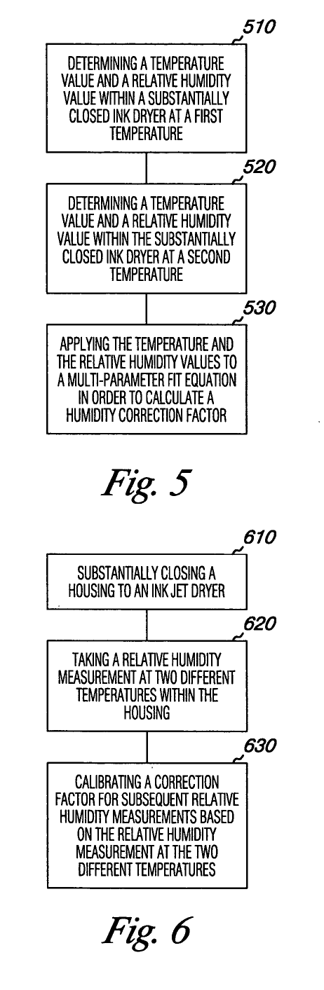

FIG. 5 illustrates another method embodiment for calibrating a media dryer. As shown in the embodiment of FIG. 5 the method includes measuring a temperature and a relative humidity within a substantially closed ink dryer at a first temperature, as shown in block 510. At block 520, the method includes measuring the temperature and the relative humidity within the substantially closed ink dryer at a second temperature. As described above, program instructions are provided on a computer readable medium which can be executed by a processor to receive temperature and relative humidity measurements taken at different temperatures by a temperature sensor and a relative humidity sensor located in a media dryer. The media dryer embodiments, as described herein, include a configuration which creates a substantially closed environment and which may also be capable of recirculating a heated gas.

Program instructions are executed to receive and record a temperature and a relative humidity measurement taken at a first temperature (T1) and to receive and record a temperature and a relative humidity measurement taken at a second temperature (T2). Again, as described herein, the substantially closed environment is to be interpreted as being provided while the media dryer is not physically in the process of drying media and as being provided while a first reading of the sensors is taken at one temperature and a second reading of the sensors is taken at another different temperature where the temperature in the media dryer has been changed, e.g., changed by operation of a heating element such as 320 in FIGS. 3A-3C under program instruction control. The substantially closed environment thus provides an environment in which the absolute humidity (e.g., total mass of water in the air of the media dryer) does not appreciably change between the two different temperature and humidity measurements.

As shown in block 530, the method includes applying the temperature and the relative humidity measurements to a multi-parameter fit equation in order to calculate a relative humidity correction factor. As one of ordinary skill in the art will appreciate, the method can also include interpolating data points for the temperature and relative humidity measurements to a table stored in a memory to produce a correction factor. Program embodiments can be executed by the relative humidity calibration module to compare a temperature and a relative humidity measurement taken at a first temperature (T1) with a temperature and a relative humidity measurement taken at a second temperature (T2) within the substantially closed media dryer environment while the media dryer is not physically in the process of drying media.

In this manner, the program instructions can execute to calculate a relative humidity correction factor to correct for a change in an accuracy of measurement readings taken by a relative humidity sensor contained in the inkjet dryer over a period of use of the inkjet dryer in the field and for inkjet dryer use under a significant range of environmental conditions. The program embodiments described herein can then execute to apply the correction factor to subsequent relative humidity measurements.

FIG. 6 illustrates another method embodiment for calibrating an inkjet dryer. As shown in the embodiment of FIG. 6 the method includes substantially closing a housing to an inkjet dryer, as shown in block 610. As described herein, program instructions can execute to substantially close the housing to the inkjet dryer between intervals of physically drying media such that the absolute humidity (e.g., total mass of water in the air of the inkjet dryer) does not appreciably change. For example, as shown in reference to FIG. 3C, the program instructions can execute to close a seal and/or cover 319 over an opening to a blower 316 as well as execute to close a seal and/or cover 313 to one or more nozzles and any other openings in the housing, e.g., a vent.

As shown in block 620, the method further includes taking a relative humidity measurement at two different temperatures within the substantially closed housing. As described above, program instructions can execute to take a relative humidity measurement at a first temperature and again at a second temperature where the temperature in the media dryer has been changed by operation of a heating element such as 320 in FIGS. 3A-3C under program instruction control while the housing remains substantially closed.

As shown in block 630, the method includes calibrating a correction factor for subsequent relative humidity measurements based on the relative humidity measurement at the two different temperatures. According to various embodiments program instructions execute to calibrate a relative humidity correction factor, e.g., by applying the relative humidity measurement at the two different temperatures to an equation or chart such as Antoine's Equation for the partial pressure of a gas, interpolation of points to a table stored in memory or other curve fit operation.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention.

It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An apparatus, comprising:
a housing in an image forming system;
a temperature sensor located within the housing;
a humidity sensor located within the housing; and
a module for humidity calibration coupled to the temperature sensor and the humidity sensor.

2. The apparatus of claim 1, wherein the housing includes a substantially closed inkjet dryer housing having a surface opposing a media path, the housing including;
a nozzle with the surface opposing the media path;
a blower connected to the housing to direct gas through the housing; and
a heating element located proximate to the blower to heat gas moving through the housing.

3. The apparatus of claim 2, wherein the housing includes a sealing mechanism to close openings to the blower and the nozzle in order to create a substantially closed environment during temperature and relative humidity measurements in between physical media drying operations.

4. The apparatus of claim 2, wherein the housing includes a first chamber and a second chamber within the first chamber, wherein the blower is connected between the first chamber and the second chamber, and wherein the temperature sensor and the heating element are located within the second chamber.

5. The apparatus of claim 4, wherein the blower creates a negative pressure to draw a gas from the first chamber into the second chamber and a positive pressure to expel the gas through the nozzle toward the media path.

6. The apparatus of claim 5, wherein gas expelled from the nozzle is drawn into the first chamber by a negative pressure of the blower.

7. The apparatus of claim 4, wherein the first chamber includes a vent, and wherein the blower creates a negative pressure to draw in ambient air to the first chamber.

8. The apparatus of claim 1, wherein the module receives temperature and relative humidity measurements over a number of intervals and uses a temperature and a relative humidity measurement at one temperature in comparison to a temperature and a relative humidity measurement at another temperature to recalibrate the relative humidity sensor.

9. The apparatus of claim 1, wherein the housing includes a surface opposing a media path, the media path includes a cylindrical drum, and wherein the surface of the housing opposing the media path covers a portion of the cylindrical drum.

10. An inkjet apparatus, comprising:
a housing including a temperature sensor and a humidity sensor; and
a module coupled to the temperature sensor and the humidity sensor to adjust the humidity sensor based on temperature and humidity measurements at different temperatures.

11. The apparatus of claim 10, wherein the humidity sensor is a relative humidity sensor, and wherein the module can compare a first temperature and relative humidity measurement at a first interval to a second temperature and relative humidity measurement at a second interval.

12. The apparatus of claim 10, wherein the housing is a substantially closed housing having a surface including a nozzle opposing a media path, and wherein the housing includes a blower to direct a gas through the housing across a heating element and to expel the gas through the nozzle.

13. The apparatus of claim 12, wherein the housing includes a first chamber and a second chamber and wherein the blower is connected between the first chamber and the second chamber, and wherein the blower creates a negative pressure to draw the gas from the first chamber into the second chamber and a positive pressure to expel the gas through the nozzle.

14. The apparatus of claim 13, wherein the first chamber encompasses the second chamber, and wherein the blower draws gas expelled through the nozzle back into the first chamber.

15. The apparatus of claim 12, wherein the surface opposing the media path includes a curved surface to approximately evenly oppose a curved media path.

16. An image forming apparatus, comprising:
a chamber have a temperature sensor and a humidity sensor; and
means for performing a humidity calibration based on temperature and humidity measurements taken from the temperature sensor and the humidity sensor.

17. The apparatus of claim 16, wherein the means includes a configuration to execute program instructions to measure accuracy change in the humidity sensor over a period of time while the humidity sensor is in a field of use.

18. The apparatus of claim 16, wherein the chamber is a substantially closed chamber having a surface with a nozzle, a blower to direct gas through the nozzle, and a heating element located proximate to the blower.

19. The apparatus of claim 16, wherein the means includes a configuration to perform the humidity calibration without using a separate test circuit or a reference sensor.

20. The apparatus of claim 16, wherein the means includes a humidity calibration module having a processor and a memory coupled to the temperature sensor and the humidity sensor.

21. The apparatus of claim 20, wherein the memory includes instructions executable by the processor to:
receive temperature and relative humidity measurements at a first temperature; and
compare the temperature and a relative humidity measurements received at the first temperature to temperature and relative humidity measurements received at a second temperature.

22. The apparatus of claim 21, wherein the means includes a configuration to execute program instructions to apply the temperature and relative humidity measurements to a multi-parameter fit equation to produce a correction factor.

23. The apparatus of claim 21, wherein the means includes a configuration to execute program instructions to interpolate data points for the temperature and relative humidity measurements to a table stored in a memory to produce a correction factor.

24. The apparatus of claim 21, wherein the means includes a configuration to execute instructions to adjust the humidity sensor based on the humidity calibration.

25. The apparatus of claim 16, wherein the means includes a configuration to measure a temperature and a relative humidity of a gas in the chamber while maintaining the chamber in a close proximity to a media path in order to create an approximately closed chamber.

26. The apparatus of claim 16, wherein the means includes a housing to encase the chamber and having walls bounding an open surface in close proximity to a media path to create an approximately closed box relative to the media path.

27. A method for calibrating, comprising:
determining temperature values and humidity values in a chamber of an image forming system at different temperatures; and
correcting humidity measurements using the temperature values and the humidity values.

28. The method of claim 27, wherein correcting the humidity measurements includes applying the temperature values and the humidity values to a multi-parameter fit equation to produce a correction factor.

29. The method of claim 28, wherein the method further includes adjusting a humidity sensor associated with the image forming sensor based on the correction factor.

30. The method of claim 27, the method further including encasing an inkjet dryer chamber having a nozzle opposing a media path with a housing having walls bounding an open surface in close proximity to the media path so as to create an approximately closed box relative to the media path.

31. The method of claim 30, wherein encasing the inkjet dryer includes encasing the dryer to calibrate and correct for a change in an accuracy of measurement readings for a relative humidity sensor contained therein over a period of use.

32. The method of claim 30, the method further including using a blower connected to the dryer chamber to create a positive pressure in the chamber and to draw a gas from within the housing into the dryer chamber.

33. The method of claim 32, the method further including using the blower to draw gas expelled from the nozzle back into the housing.

34. The method of claim 27, the method further including providing a calibrated relative humidity feedback to a relative humidity sensor located in the chamber.

35. An image forming system, comprising:
an ink deposition mechanism; and
an apparatus to dry media having ink, including;
a chamber;
a temperature sensor located inside the chamber;
a humidity sensor located inside the chamber; and
a calibration module coupled to the temperature sensor and the humidity sensor to calibrate humidity based on temperature and relative humidity measurements.

36. The system of claim 35, wherein the calibration module is configured to calibrate humidity which the system is in a field of use.

37. The system of claim 35, the system further including a media path to convey media past the ink deposition mechanism.

38. The system of claim 35, wherein the calibration module can measure accuracy change in the humidity sensor over a period of time.

39. The system of claim 38, wherein the calibration module can provide a feedback to the humidity sensor to correct for accuracy change in the sensor while the system is in a field of use without involving a separate test circuit or a reference sensor.

40. A computer readable medium having instructions for causing a device to perform a method, comprising:
determining temperature values and humidity values in a chamber of an image forming system at different temperatures; and
correcting humidity measurements using the temperature values and the humidity values.

41. The medium of claim 40, wherein correcting the humidity measurements includes applying the temperature values and the humidity values to a multi-parameter fit equation to produce a correction factor.

42. The medium of claim 41, wherein the method further includes adjusting a humidity sensor associated with the image forming sensor based on the correction factor.

43. The medium of claim 41, wherein the method further includes applying the correction factor to subsequent humidity values.

44. The medium of claim 40, wherein correcting the humidity measurements includes interpolating data points for the temperature values and humidity values to a table stored in a memory to produce the correction factor.

45. A dryer having a first and a second chamber, the second chamber disposed at least partially inside the first chamber;
a gas handling device positioned to pressurize the second chamber with gas from the first chamber;
a heating element disposed inside the dryer for heating the gas; and
a number of apertures formed in the second chamber to permit the gas within the second chamber to pass through the apertures, the first chamber having an inlet positioned adjacent the apertures to permit at least some of the gas that passes through the apertures to enter the inlet of the first chamber and be circulated back into the second chamber through the gas handling device.

46. The dryer of claim 45, wherein the gas handling device is a blower.

47. The dryer of claim 45, further comprising:
an ink deposition area; and
a media conveyance mechanism for advancing media past the ink deposition area to the dryer.

48. A method, comprising:
drawing gas from a media path to hold media at the media path;
routing the gas to a dryer; and
directing the gas toward the media path.

49. The method of claim 48, further comprising at least partially forming an image on the media while the media is at the media path.

50. The method of claim 48, further comprising heating the gas at the dryer.

51. A method comprising:
at least partially forming an image on a media disposed on a media path;
directing gas from a dryer at the media path; and
circulating the gas from the media path back to the dryer.

52. The method of claim 51, further comprising heating the gas at the dryer.

53. A device comprising:
an ink deposition area disposed adjacent a media path;
means for directing gas from a dryer at the media path; and
means for circulating the gas from the media path back to the dryer.

54. The device of claim 53, wherein the means for directing gas includes a number of apertures formed between the dryer and the media path and oriented to direct gas from the dryer at the media path.

55. The device of claim 53, wherein the means for directing gas includes a gas conveyance mechanism.

56. The device of claim 53, wherein the means for circulating the gas includes an inlet positioned to permit at least some of the gas directed at the media path to enter the inlet and be circulated back into the dryer.
